(19) United States
(12) Patent Application Publication
(10) Pub. No.: US 2023/0408703 A1
(43) Pub. Date: Dec. 21, 2023

(54) VALIDATION OF A VEHICLE POSITION

(71) Applicant: AVL LIST GMBH, Gaz (AT)

(72) Inventor: Peter Priller, Gratwein-Straßengel (AT)

(21) Appl. No.: 18/035,789

(22) PCT Filed: Nov. 8, 2021
(86) PCT No.: PCT/AT2021/060412

§ 371 Date: May 8, 2023

(30) Foreign Application Priority Data
Nov. 9, 2020 (AT) A50965/2020

(51) Int. Cl. G01S 19/21; H04W 4/44; H04W 4/029; H04W 4/46

(52) U.S. Cl. CPC G01S 19/215; H04W 4/44; H04W 4/029; H04W 4/46

(57) ABSTRACT

In order to devise a method for validating a assumed position (P1) of a vehicle, a vehicle receiver (1) receives a V2X message (3) transmitted by a transmitter (2) and determines a position (p2) of the transmitter (2) from the V2X message, wherein local environmental geodata comprising positions of a number of stationary objects (O1, O2, O3, O4) is made available, a signal path (x) of the V2X message (3) is simulated on the basis of the transmitter position (p2) taking into account the environmental geodata and the assumed vehicle position (P1), and at least one simulated physical received signal property is determined from the simulated signal path (x) and the assumed vehicle position (P1). When receiving the V2X message, at least one actual physical received signal property of the V2X message (3) is determined, and the assumed vehicle position (P1) is validated if the at least one simulated physical received signal property differs from the at least one actual physical received signal property by less than a limit value (G).

The present invention relates to a method for validating an assumed position of a vehicle. The present invention further relates to a validation device for validating an assumed vehicle position specified by a position-determination unit of a vehicle.

A position-determination unit is provided on the vehicle for determining a vehicle position of a vehicle. The position-determination unit communicates, for example, with a satellite navigation system (for example, a GNSS/GPS satellite), which provides the position-determination unit with a position signal for determining the assumed vehicle position. In the case of so-called GNSS spoofing, an incorrect vehicle position is generated, for example by an attacker generating a falsified position signal which is stronger than the position signal of the satellite navigation system, and is accepted accordingly by the position-determination unit. This can result in an incorrect calculation of the vehicle position. In other words, an attacker can specify where a position-determination unit “considers” itself to be. Of course, the position-determination unit can also determine an incorrect vehicle position for other reasons, i.e., “by mistake”. In either case, an incorrect assessment of a driving situation can be made on the basis of incorrect information. It thus can be the case, that inefficient or even dangerous actions are triggered in advanced driver assistance systems (ADAS) and/or in partially automated/fully automated driving systems (AD). For example, cases are known in which an emergency braking function of a vehicle was activated by a falsified instruction.

For this reason, it is desirable to validate the vehicle position. DE 10 2015 211 279 A1 describes a method for detecting GPS spoofing by determining the vehicle position on the basis of objects in the surroundings and comparison with the received GPS signal. In this case, maps are also used to determine whether the position specified by the GPS system is plausible, wherein cameras recognize objects in the surroundings and compare them with the map. DE 10 2017 209 5 594 A1 discloses a detection of GNSS spoofing, wherein the GNSS position is compared with a position extracted from a V2X message. This is done by comparing the positions, determined by means of GNSS, of a plurality of road users. For example, they cannot be at the same location at the same time. Map data can be used additionally to prevent a spoofing being inferred from a comparison, by mistake, when road users are located above on different levels on top of each other, for example.

Methods are also known which detect an (incidence) direction of the satellite signal. In this way, GNSS spoofing can be detected, since ground-based signals can be distinguished from satellite signals.

It is an object of the present invention to specify a method for authenticating an assumed vehicle position.

This object is achieved according to the invention by a vehicle receiver of the vehicle receiving a V2X message transmitted by a transmitter, and a transmitter position of the transmitter being determined from the V2X message, wherein local environmental geodata comprising positions of a number of stationary objects are made available, wherein a signal path of the V2X message is simulated on the basis of the transmitter position, taking into account the environmental geodata and the assumed vehicle position, wherein at least one simulated physical received signal property is determined from the simulated signal path and from the assumed vehicle position, at least one actual physical received signal property of the V2X message is determined when the V2X message is received, and the assumed vehicle position is validated if the at least one simulated physical received signal property differs from the at least one actual physical received signal property by less than a limit value.

Furthermore, the object is achieved by a validation device, wherein an extraction unit is provided which is designed to determine from the V2X message a transmitter position of the transmitter upon reception of a V2X message transmitted by a transmitter and received by a receiver of the vehicle, wherein an analysis unit is provided which is designed to determine at least one actual physical received signal property upon reception of the V2X message, wherein a geodata unit is provided which is designed to provide local environmental geodata comprising positions of a number of stationary objects, a simulation unit is provided which is connected to the extraction unit and the geodata unit and is designed to simulate a signal path of the V2X message by using the transmitter position, the local environmental geodata and the assumed vehicle position, and to determine at least one simulated physical received signal property from the simulated signal path and the assumed vehicle position, and wherein a validation unit is provided which is connected to the simulation unit and to the analysis unit and is designed to validate the assumed vehicle position, if the at least one simulated physical received signal property differs from the at least one actual physical received signal property by less than a limit value. Of course, the validation device and its subordinate units can be designed to also carry out the further method steps described in the following. A label is considered to be trustworthy as a validation.

According to the invention, it is not merely a potential physical received signal property based on the relative positioning of transmitter and receiver (i.e., distance and orientation) that is calculated and compared with an actual physical received signal property of the received V2X message but rather a signal path is simulated taking into account local environmental geodata. Thus, for the simulated signal path, not only the relative positioning of transmitter and receiver is decisive, but also local geodata which influence the signal path. Simulating the signal path while taking into account local environmental geodata makes it more difficult for an attacker to generate a falsified vehicle position, since a falsified vehicle position leads to an incorrect simulated signal path, which results in the simulated physical received signal properties not matching the actual physical received signal properties.

The “assumed vehicle position” is basically the vehicle position specified or determined by the position-determination unit, which can correspond to the actual vehicle position or can differ from the actual vehicle position.

The environmental geodata can be geographical maps (for example, OpenStreetMap) in which stationary objects such as houses, plants, etc. are recorded. After assignment of the transmitter position and of the assumed vehicle position in relation to the stationary objects in the surroundings of the transmitter and the receiver, the signal path can be simulated starting from the transmitter and taking into account the stationary objects. By taking into account the local geodata during the simulation of the signal path, the physical received signal properties can be “affected” by the geodata. Affecting is understood to mean the detection of objects along the path between the transmitter and the receiver. Since the path changes when the transmitter and/or receiver are moving, during the course of communication correspondingly different stationary objects flow into the communication. The number of objects that were in the path thus increases. The effect that an object has on a received signal and thus on the physical received signal properties can be expressed, for example, in the form of signal attenuation by the object and/or reflection at the object.

A general communication of a vehicle with another participant is referred to as V2X communication (vehicle-to-X communication) or C2X communication (car-to-X communication), wherein V2X messages are transmitted. A distinction is also made between the different participants. Communication between a vehicle and further vehicles is referred to as V2V (vehicle-to-vehicle communication) or C2C communication (car-to-car communication), whereas communication between a vehicle and infrastructure and/or external IT systems and/or external IT services is referred to as V21 (vehicle-to-infrastructure communication). In contrast, communication between a vehicle and cloud infrastructure is often referred to as V2C communication (vehicle-to-cloud communication), communication between a vehicle and terminals (e.g., smartphones) of other road users (pedestrians, cyclists, etc.) as V2P communication (vehicle-to-person communication or vehicle-to-pedestrian communication).

For the types of communication mentioned, a WLAN-like IEEE 802.11p standard is defined, on the one hand, which enables a message transmission at a frequency in the 5.9 GHz band. On the other hand, C-ITS, a mobile-radio-based approach for 4G (LTE) and 5G networks, is also defined, which enables a message transmission in the 1.8 to 3.5 GHz frequency band. In the standards mentioned, so-called CAMs (common awareness messages) are defined as V2V messages wherein vehicles transmit among other things their position, direction and speed several times per second, e.g., 10 times per second.

A V2X message can basically comprise information regarding the transmitter (vehicle, infrastructure, etc.) itself and/or regarding other vehicles, e.g., regarding position, speed or the (immediately planned) trajectory of the vehicles in question. This information will have been determined, for example, in advance by the vehicle itself or received via a V2X message from other participants. Furthermore, the message can also comprise information about the infrastructure, for example regarding the position/arrangement of roads, traffic lights, construction sites, etc., wherein the associated status (blocked lanes, current traffic light phases, etc.) can also be included as information. The V2X message is transmitted as a broadcast to all (potential) receivers within the transmission range of the transmitter (usually several tens to several hundred meters). This results in the vehicle receiving only local information, i.e., information within the area of the transmission range and therefore also relevant information.

The V2X message received by a receiver of a vehicle, i.e., the information contained therein, can be used and/or processed by further vehicle systems, for example by driver assistance systems (ADAS) and/or partially automated/fully automated driving systems (AD). For example, the received information can serve to detect objects (for example, vehicles, infrastructure, etc.) in the surroundings of the vehicle, and thus to support the sensors (video, radar, lidar, etc.) installed in the vehicle. This is particularly advantageous since the V2X message can also contain information relating to objects which cannot be detected by the sensors installed in the vehicle. This can be due to a limited range or to occlusions (non-line-of-sight, NLS) of the sensors or even to disruptive environmental conditions (e.g., weather conditions). Information received by means of V2X messages can thus serve, in conjunction with existing sensors, to supplement a situation picture regarding the surroundings of the vehicle. The information contained in the V2X message can also be displayed to the driver, wherein the information can also be processed. For example, information about roadway restrictions in the area of construction sites that is received via V2X message can be displayed to the driver.

The received V2X message can also contain information provided by other participants (e.g., vehicles). As a result of an overall consideration of the information in the V2X messages of a plurality of participants, a dense picture of the local scenario can be generated, whereby, for example, collaborative driving (collective perception messages, CPM) can be supported.

When simulating the signal path, a reflection and/or a diffraction and/or an absorption of the V2X message at stationary objects can be taken into account. Complete absorption and/or partial absorption can be taken into account as absorption. Furthermore, methods such as ray tracing can be used to simulate the signal path.

The simulated signal path and/or the simulated physical received signal property is preferably simulated by means of physical and/or stochastic models and/or with the aid of approximation methods based on machine learning, preferably specially trained neural networks. The computing power required for the simulation can thus be kept low. For example, highly optimized algorithms can also be used, such as the “geometry-based stochastic channel model” (M. Hofer et al., “Evaluation of vehicle-in-the-loop tests for wireless V2X communication,” 2019 IEEE 90th Vehicle Technology Conference (VTC2019-Fall), Honolulu, HI, USA, 2019, pp. 1-5).

The local environmental geodata preferably comprise physical object properties of the objects. For example, signal-specific physical object properties such as reflection indices and/or signal attenuation of the objects can be contained directly in the local environmental geodata. Signal-specific physical object properties can in particular comprise those physical object properties of the objects which influence channel properties for the frequencies used (e.g., 1.8 to 3.5 or 5 GHz). It is also possible for only physical object properties, such as for example the object type of the objects (tree, bush, building, mound, etc.) to be contained in the local environmental geodata. The signal-specific physical object properties can in turn be derived on the basis of the physical object properties.

An actual reception angle is preferably determined as at least one physical received signal property and a simulated reception angle is determined as at least one simulated physical received signal property. If the local geodata are not taken into account during simulation of the signal path, a signal reception angle will not be simulated correctly in the case of a reflection at objects, since the signal path and thus also the signal reception angle are influenced by reflections. In order to determine the actual reception angle, a direction-sensitive antenna (DOA, direction of arrival) can be used, for example an ESPAR antenna (electronically steerable parasitic array radiator).

An actual received signal strength is preferably determined as at least one physical received signal property and a simulated received signal strength is determined as at least one simulated physical received signal property. If the local geodata were not taken into account, it would not be possible to tell whether a low signal strength is present due to a great distance from the vehicle, or due to objects positioned in the surroundings of the transmitter and/or receiver.

Furthermore, polarization and/or Doppler shift and/or frequency dispersion and/or signal transit times can be provided as a physical received signal property (and correspondingly as a simulated physical received signal property).

The transmitter position may be included directly in the V2X message. The transmitter position thus needs only to be read out from the V2X message. However, the transmitter position can also be derived from other information contained in the V2X message.

Preferably, the assumed vehicle position is declared invalid, if the at least one simulated physical received signal property differs from the at least one actual physical received signal property by at least the limit value. The assumed vehicle position is thus invalidated if it has not been validated.

In the case of the assumed vehicle position being declared invalid, a position-determination unit which determines the assumed vehicle position can be marked as unreliable.

Furthermore, if the assumed vehicle position has been declared invalid, a satellite navigation system which provides the position-determination unit with a position signal for determining the assumed vehicle position can be marked as unreliable. Furthermore, a message can be sent regarding the unreliability of the GNSS transmitter or regarding a suspicion that GNSS signals have been modified or overlaid in such a way that incorrect position statements may result, which message is transmitted, for example, as a broadcast to the vehicles in the surroundings and/or to a central location (e.g., a traffic control center).

Validation is advantageously carried out several times. Since the transmitter and/or receiver are in motion and thus travel over an increasing area over time and the transmission path is thus influenced by an increasing number of stationary objects, the above-described “affecting” of the physical received signal property increases and thus the informative power of the validation.

The actual vehicle position can be determined using the local environmental geodata and the actual physical received signal property of the V2X message and compared with the assumed vehicle position. The actual vehicle position is thus estimated, e.g., by simulating the actual signal path on the basis of the reception direction and the reception field strength of the V2X message and also the local environmental geodata. As a result, the actual vehicle position can be compared with the assumed vehicle position in order to enable an additional validation should the actual vehicle position and the assumed vehicle position differ by less than a corresponding position deviation limit value.

The V2X message is preferably a V2V message, preferably a common awareness message.

As is known, the vehicle position may be used in the vehicle to perform partially or fully automated driving. If the vehicle position has been validated, it can be used for the partially or fully automated driving function. However, if the vehicle position is declared invalid, it will not be used for the automated driving function. If further available information (e.g., information determined by existing sensors) is not sufficient for safe performance of the automated driving function, this function can subsequently be deactivated. In this case, full control over the vehicle can be transferred to the driver or a safe stop of the vehicle initiated. It can also occur that the further information present is not sufficient for the complete automated driving function but does allow a limited function, for example a reduced speed.

Furthermore, the vehicle position can be displayed in the vehicle and a note regarding the validation of the vehicle position can also be displayed. On the one hand, the driver is thus informed of the vehicle position and, on the other hand, whether this vehicle position has been validated.

Likewise, the vehicle position can be stored in a system of the vehicle (for example, an accident data recorder (also called a black box), driving data recorder, etc.), and a note regarding the validation vehicle position can also be stored.

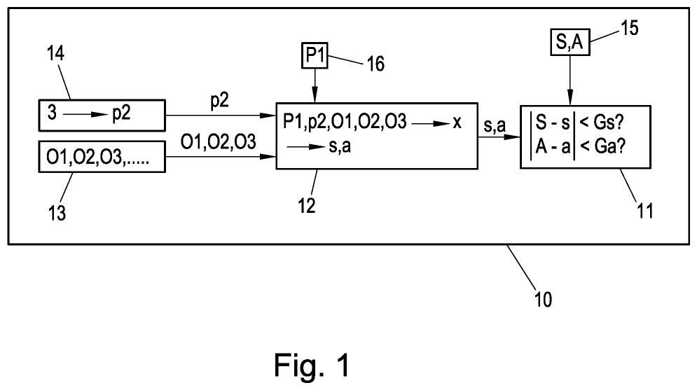

The present invention is described in greater detail below with reference to FIGS. 1 to 4, which show, by way of example and in a schematic and non-limiting manner, advantageous embodiments of the invention. The following are shown:

FIG. 1 an exemplary schematic structure of a validation device

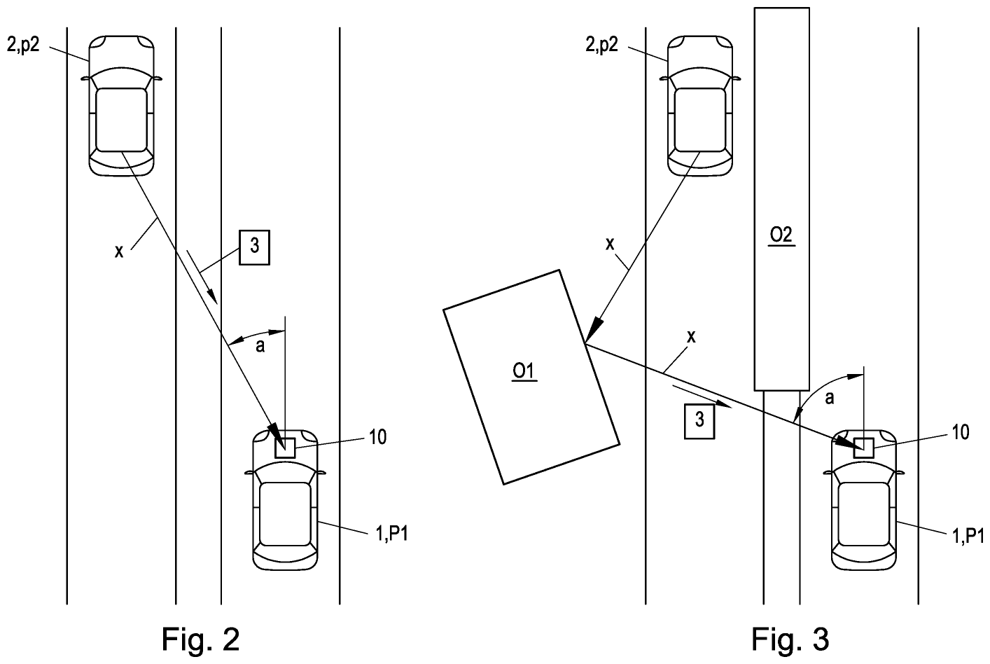

FIG. 2 a direct simulated signal path of a V2X message,

FIG. 3 a simulated signal path of a V2X message reflected at an object,

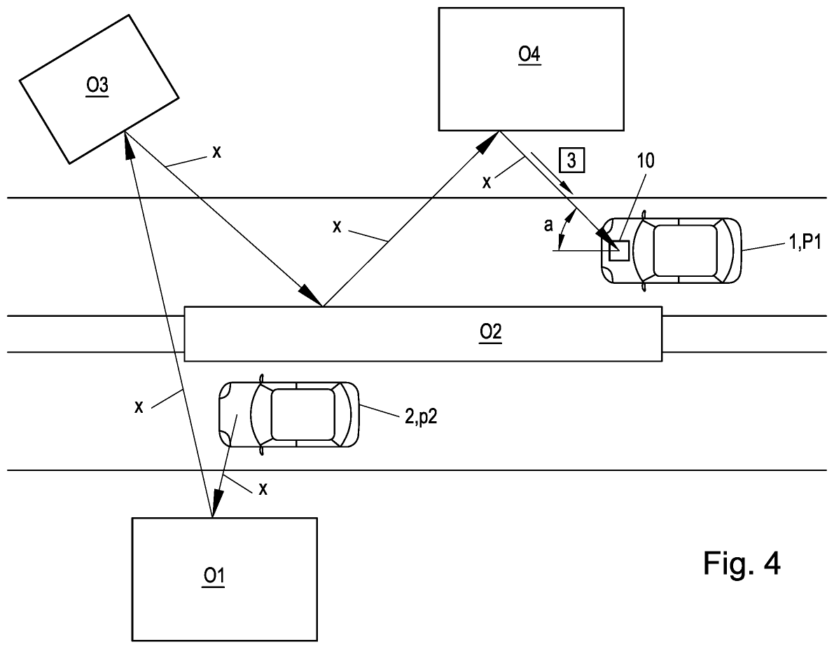

FIG. 4 a simulated signal path of a V2X message reflected at two objects.

A position-determination unit 16 is provided on a vehicle, which position-determination unit is designed to determine the assumed vehicle position P1 of the vehicle. The position-determination unit 16 receives, for example, a position signal from a satellite navigation system for determining the assumed vehicle position P1. It may happen that the assumed vehicle position P1 specified by the position-determination unit 16 is incorrect. An incorrectly assumed vehicle position P1 can be falsified (for example, based on GNSS spoofing), or can also be unintentionally incorrect.

A validation device 10 as schematically illustrated in FIG. 1 is provided on the vehicle for validating the assumed vehicle position P1. A V2X message 3 is transmitted from a transmitter 2 to a receiver 1 of the vehicle. A vehicle (V2V message), but also an infrastructure, an external IT system, an external IT service (V21 message), another road user (V2P message), a cloud service (V2C message), etc. can be provided as the transmitter 2. The V2X message 3 directly includes a transmitter position p2 of the transmitter 2 or contains information from which the transmitter position p2 can be derived. For communication with a cloud service (V2C message), the position of the active radio mast (for example, a mobile radio transmission mast at C-ITS) can be regarded as transmitter position p2. An extraction unit 14 is provided, which serves to determine the transmitter position p2 from the V2X message 3. It is assumed that this transmitter position p2 is correct.

Furthermore, an analysis unit 15 is provided which is designed to determine, upon reception of the V2X message 3, at least one actual physical received signal property of the V2X message 3, for example, an actual received signal strength S and/or an actual received signal angle A.

According to the invention, a geodata unit 13 is provided, which is designed to provide local environmental geodata. The environmental geodata comprise positions of stationary objects O1, O2, O3, O4, for example in the form of 2D maps, or 3D maps. A local memory with positions of the stationary objects O1, O2, O3, O4 and/or a receiving unit for receiving the position of the stationary objects O1, O2, O3, O4 can be provided as geodata unit 13. An exemplary positioning of stationary objects O1, O2, O3, O4 is shown in FIGS. 2 to 4 and will be described further below.

In addition, according to the invention, a simulation unit 12 is provided which receives from the extraction unit 14 the transmitter position p2 of the transmitter 2. Furthermore, the simulation unit 12 receives the environmental geodata O1, O2, O3, O4 provided by the geodata unit 13. The simulation unit 12 simulates the signal path x of the V2X message 3 from the transmitter position p2 to the assumed vehicle position P1 taking into account the stationary objects O1, O2, O3, O4. Furthermore, at least one simulated physical received signal property, for example a simulated received signal strength s and/or a simulated received signal angle a, is determined from the simulated signal path x and the assumed vehicle position P1. The simulated received signal strength s is dependent on the length of the simulated signal path x and the object types and/or object properties of the objects O1, O2, O3, O4 positioned along the signal path x. For example, trees have a signal-attenuating effect. The simulated received signal angle a results from the orientation of the simulated signal path x impinging on the receiver 1.

In order to verify that the simulated signal path x corresponds to the actual signal path, a validation unit 11 is provided which receives the at least one simulated physical received signal property from a simulation unit 12 and the at least one actual signal property from the analysis unit 15. The at least one simulated physical received signal property is compared with the at least one actual signal property. If the at least one simulated physical received signal property differs from the at least one actual physical received signal property by less than a limit value G, the V2X message 3 will be validated. It is thus concluded from a correct physical received signal property (i.e., a difference by less than the limit value G from the actual signal property) that the simulated signal path x is correct, whereby it is again inferred that the assumed vehicle position P1 is correct, i.e., corresponds to the actual vehicle position. It can be concluded analogously from an incorrect physical received signal property (i.e., a difference by at least the limit value G from the actual signal property) that the simulated signal path x is incorrect, whereby it is again inferred that the assumed vehicle position P1 is incorrect, i.e., does not correspond to the actual vehicle position.

A simulated physical received signal property can be compared with an actual physical received signal property, or a plurality of simulated physical received signal properties can be compared with a plurality of actual physical received signal properties, wherein limit values can be provided in each case. FIG. 1, by way of example, provides on the one hand a comparison of the simulated received signal strength s with the actual received signal strength S and, on the other hand, a comparison of the simulated reception angle a with the actual reception angle A. The transmitter 2 preferably transmits the V2X message 3 omnidirectionally, i.e., in the two-dimensional representation uniformly in all directions of the plane parallel to a roadway plane. The difference is calculated from the simulated received signal strength s and the actual received signal strength S and the absolute value of the difference is compared with a signal strength limit value Gs: |S−s|<Gs. Furthermore, the difference is calculated from the simulated reception angle a and the actual reception angle A and the absolute value of the difference is compared with an angle limit value Ga: |A−a|<Ga. When validating the reception angle A, it is of course taken into account that 0° corresponds to 360°. Thus, for example, at a reception angle A of 359° and a simulated reception angle a of 1°, a difference of 2° and not 358° is determined. Due to the formation of the absolute value of the difference, the same limit value is provided for a positive difference and for a negative difference, and a comparison with an upper limit value can of course also be carried out for a positive difference and a comparison with a lower limit value can be carried out for a negative difference.

In FIGS. 2, 3 and 4, an assumed vehicle position P1 and the simulated signal path x are shown in each case. If the vehicle 1 were actually located at the vehicle position P1, the actual signal path would also correspond to the simulated signal path x. The transmitter 2 is represented in the figures only by way of example as a vehicle, as a result of which the V2X message 3 represents a V2V message.

It is assumed in FIG. 2 that no object O1, O2, O3, O4 is located between the transmitter 2 and the receiver 1, as a result of which the V2X message 3 is transmitted along a direct simulated signal path x from the transmitter 2 to the receiver 1. This results in a simulated reception angle a and a simulated received signal strength s (not shown) for the received V2X message 3. The illustration in FIG. 2 is of course only theoretical in nature, since a complete absence of objects O1, O2, O3, O4 is highly unlikely.

FIG. 3 shows the same relative positioning of the transmitter 2 and receiver 1 as in FIG. 2. However, another simulated signal path x occurs here, which is due to the position of the second object O2 between the transmitter 2 and the vehicle 1, which object is preventing a direct simulated signal path x as shown in FIG. 1. However, a first object O1 is present, at which the V2X message 3 is reflected. The simulated signal path x thus leads from the transmitter 2 to the first object O1, at which the V2X message 3 is reflected, and onward to the receiver 1. FIG. 3 thus shows a different (in this case more obtuse) simulated reception angle a of the V2X message as compared to FIG. 2. Likewise, in FIG. 4, compared to FIG. 2, a different (here reduced) simulated received signal strength s occurs (not shown), which is due to the longer simulated signal path x.

FIG. 4 also shows the same relative arrangement of the transmitter 2 and receiver 1, wherein again a different simulated signal path x occurs, since the V2X message 3 is reflected multiple times. The simulated signal path x of the V2X message 3 thus leads from the transmitter 2 via a reflection at the first object 1 to a reflection at the third object O3 and via further reflections at the second object O2 and the fourth object O4 to the receiver 1. This results in an entirely different simulated reception angle a of the V2X message 3 in FIG. 4 compared to FIGS. 2 and 3. In addition, due to the again longer simulated signal path x compared to FIGS. 1 and 2, a further reduced simulated received signal strength S occurs (not shown).

It is thus apparent that the physical received signal properties depend strongly on the local objects O1, O2, O3, O4 in the surroundings of the transmitter 2 and the receiver 1. A signal path x can thus be simulated on the basis of the transmitter position p2 and the local geodata and the assumed vehicle position P1, from which in turn physical received signal properties can be simulated. The actual signal properties are determined and compared with the simulated physical received signal properties in order to determine whether the simulated signal path x matches the actual signal path. If this is the case, it can be assumed that the assumed vehicle position P1 corresponds to the actual vehicle position, whereby the V2X message 3 can be validated.

In the figures, the signal path x is shown highly simplified for better illustration, wherein, in addition to simple shielding effects, only a simple reflection is taken into account while assuming an angle of reflection corresponding to the angle of incidence. In addition to the effects of reflection and shielding, further effects can be taken into account in the simulation of the signal path x, for example also diffraction etc. In the simulation, a plurality of signal paths x can also be taken into account, wherein effects such as (different) signal transit times etc. can in turn be taken into account.

The extraction unit 14, analysis unit 15, geodata unit 13, simulation unit 12, validation unit 11 and position-determination unit 16 can be designed as microprocessor-based hardware, for example as a computer or digital signal processor (DSP) on which corresponding software for performing the respective function is executed. The extraction unit 14, analysis unit 15, geodata unit 13, simulation unit 12, validation unit 11 and position-determination unit 16 can also be in each case an integrated circuit, for example, an application-specific integrated circuit (ASIC) or a field-programmable gate array (FPGA), also with a microprocessor. However, the extraction unit 14, analysis unit 15, geodata unit 13, simulation unit 12, validation unit 11 and position-determination unit 16 can also be implemented as an analog circuit or analog computer. Mixed forms are conceivable as well. Likewise, it is possible for different functions to be implemented as software on the same hardware.

1. A method for validating an assumed position (P1) of a vehicle, comprising:
receiving, with a receiver of the vehicle a V2X message transmitted by a transmitter; and
determining a position of the transmitter from the V2X message, in that local environmental geodata comprising a positioning of a number of stationary objects are made available, wherein a signal path (x) of the V2X message is simulated based on the position of the transmitter and taking into account the environmental geodata and the assumed vehicle position, wherein at least one simulated physical received signal property is determined from the simulated signal path and the assumed vehicle position, in that at least one actual physical received signal property of the V2X message is determined upon reception of the V2X message, and in that the assumed vehicle position is validated, if the at least one simulated physical received signal property differs from the at least one actual physical received signal property by less than a limit value.

2. The method according to claim 1, further comprising taking into account a reflection of the V2X message at the stationary objects, when simulating the signal path (x).

3. The method according to claim 2, wherein the local environmental geodata includes properties selected from the group consisting of physical object properties, reflection properties, and attenuation properties, of the stationary objects.

4. The method according to claim 1, further comprising determining an actual reception angle as at least one physical received signal property and determining a simulated reception angle as at least one simulated physical received signal property.

5. The method according to claim 1, further comprising determining an actual received signal strength as at least one physical received signal property, and determining a simulated received signal strength as at least one simulated physical received signal property.

6. The method according to claim 1, wherein the transmitter position is directly contained in the V2X message.

7. The method according to claim 1, further comprising deriving the transmitter position from information contained in the V2X message.

8. The method according to claim 1, further comprising declaring the assumed vehicle position invalid, if the at least one simulated physical received signal property differs from the at least one actual physical received signal property by at least the limit value (G).

9. The method according to claim 8, further comprising marking a position-determination unit (16) which is determining the assumed vehicle position as unreliable, if the assumed vehicle position is declared invalid.

10. The method according to claim 8, further comprising marking a satellite navigation system which is providing a position signal to the position-determination unit for determining the assumed vehicle position as unreliable, if the assumed vehicle position is declared invalid.

11. The method according to claim 1, further comprising carrying out the validation multiple times.

12. The method according to claim 1, further comprising determining the actual vehicle position is using the local environmental geodata and actual physical received signal properties of the V2X message and comparing the actual vehicle position with the assumed vehicle position of the transmitter.

13. The method according to claim 1, wherein the V2X message is a V2V message, preferably a common awareness message.

14. The method according to claim 1, further comprising simulating the simulated signal path by using a model selected form the group consisting of a physical model, a stochastic model, and approximation methods based on machine learning.

15. A validation device for validating an assumed vehicle position specified by a position-determination unit of a vehicle, comprising:
an extraction unit, which is configured to determine a transmitter position of the transmitter from the V2X message, upon reception of a V2X message transmitted by a transmitter and received by a receiver of the vehicle;
an analysis unit, which is configured to determine at least one actual physical received signal property when the V2X message is received;
a geodata unit, which is configured to provide local environmental geodata comprising a positioning of a number of stationary objects;
a simulation unit, which is connected to the extraction unit and to the geodata unit and which is configured to simulate a signal path of the V2X message using the transmitter position, the local environmental geodata and the assumed vehicle position, and to determine at least one simulated physical received signal property from the simulated signal path and the assumed vehicle position;
a validation unit, which is connected to the simulation unit and to the analysis unit and which is configured to validate the assumed vehicle position (P1), if the at least one simulated physical received signal property differs from the at least one actual physical received signal property by less than a limit value.

16. The method according to claim 1, further comprising simulating the simulated physical received signal property by using a model selected from the group consisting of a physical model, a stochastic model, and approximation methods based on machine learning.

17. The method according to claim 1, further comprising taking into account a diffraction of the V2X message at the stationary objects, when simulating the signal path.

18. The method according to claim 1, further comprising taking into account an absorption of the V2X message at the stationary objects, when simulating the signal path (x).
